(19) United States
(12) Patent Application Publication
(10) Pub. No.: US 2010/0107645 A1
(43) Pub. Date: May 6, 2010

(54) Combustor liner cooling flow disseminator and related method

(75) Inventor: Vighneswara Rao Kollati, Andhra Pradesh (IN)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 12/289,704

(22) Filed: Oct. 31, 2008

(51) Int. Cl. F02C 7/18

(52) U.S. Cl. 60/752

(57) ABSTRACT

A combustor component includes a hollow cylindrical body, at least a section of which is provided with a plurality of annular, axially spaced shoulders. A plurality of rings are provided on an interior side of the section of the cylindrical body, aligned with the shoulders to thereby create a like plurality of annular slots. A plurality of cooling holes are formed in section of the cylindrical body, radially overlying the rings, and adapted to supply cooling air to the annular slots. A plurality of flow disseminators are provided on a radially outer side of the rings, aligned with the cooling holes, and configured to spread the cooling air flowing through the cooling holes.

This invention relates generally to gas turbine combustor technology and, more particularly, to film cooled combustor liners.

### BACKGROUND OF THE INVENTION

Conventional gas turbine combustion systems employ multiple combustor assemblies to achieve reliable and efficient turbine operation. Each combustor assembly includes a cylindrical liner, a fuel injection system, and a transition piece that guides the flow of hot combustion gases from the combustor to an inlet to the turbine first stage. Generally, a portion of the compressor discharge air is used to cool the combustor liner and is then introduced into the combustor reaction zone to be mixed with the fuel and burned.

Because they are exposed to intense heat generated by the combustion process, combustor liners are cooled to meet life expectancy requirements. Liner cooling is commonly provided by diverting a portion of the compressed air, causing it to flow over the outer surfaces of the liners. In addition, a thin layer of cooling air is provided along the combustion side of the liners by directing cooling air flow through cooling holes formed in the liners. This technique, referred to as film cooling, reduces the overall thermal load on the liners because the mass flow through the cooling holes dilutes the hot combustion gas next to the liner surfaces, and the flow through the holes provides convective cooling of the liner walls.

In one known configuration, film cooled combustor liners include a series of connected panel sections with one or more annular shoulders formed in each of the panel sections. Each shoulder defines in combination with an annular ring on the interior surface of the panel section, an underlying axially-oriented slot or louver formed on the hot gas side thereof, with a plurality of cooling holes is formed in each shoulder. The compressor discharge air passes through the cooling holes and exits and the cooling slots to produce a film of cooling air on the hot gas side of the corresponding panel section.

Conventional slot cooling methods can, however, result in local thermal gradients and increased pressure loss due to the stagnation of the jet which in turn, could lead to reduction in the life of the liner.

There remains a need, therefore, for effective and efficient cooling of combustor liners that will reduce the effect of local thermal gradients and increased pressure loss.

### BRIEF DESCRIPTION OF THE INVENTION

In an/one aspect, the present invention relates to a combustor component comprising: a hollow cylindrical body, at least a section of which is provided with a plurality of annular, axially spaced shoulders; a plurality of rings on an interior side of the section of the cylindrical body, aligned with the shoulders to thereby create a like plurality of annular slots; a plurality of cooling holes in the section of the cylindrical body radially overlying the rings, and adapted to supply cooling air to the annular slots; and a plurality of flow disseminators on a radially outer side of the rings, aligned with the cooling holes, and configured to spread the cooling air flowing through the cooling holes.

In another aspect, the invention relates to a combustor liner comprising: a hollow cylindrical body, at least a forward section of which is provided with a plurality of annular, axially spaced shoulders; a plurality of rings on an interior side of the forward section of the cylindrical body, aligned with the shoulders to thereby create a like plurality of axially-facing annular slots; a plurality of cooling holes in the forward section of the cylindrical body, radially overlying the rings, and adapted to supply cooling air to the axially-facing annular slots; and a plurality of circumferentially-spaced, elongated flow disseminators on a radially outer side of the rings, the flow disseminators each having a bell-shaped transverse cross section including a radially outwardly convex apex aligned with the cooling holes, and configured to spread the cooling air flowing through the cooling holes.

In still another aspect, the invention relates to a method of cooling a combustor liner comprising: (a) supplying cooling air though a plurality of cooling holes in the liner to a plurality of axially-spaced annular slots formed in the liner, radially inwardly of the holes; and (b) disseminating the cooling air exiting at least some of the cooling holes by spreading the flow in at least two substantially opposite circumferential directions.

The invention will now be described in further detail in connection with the drawings identified below.

### BRIEF DESCRIPTION OF THE DRAWINGS

FIG. 1 is a partially cut-away perspective view of a known combustor liner;

FIG. 2 is an enlarged detail taken from FIG. 1;

FIG. 3 is a view similar to FIG. 2 but reoriented to a sectioned elevation view; and

FIG. 4 is an enlarged detail of a combustor liner illustrating an exemplary implementation of the invention.

### DETAILED DESCRIPTION OF THE INVENTION

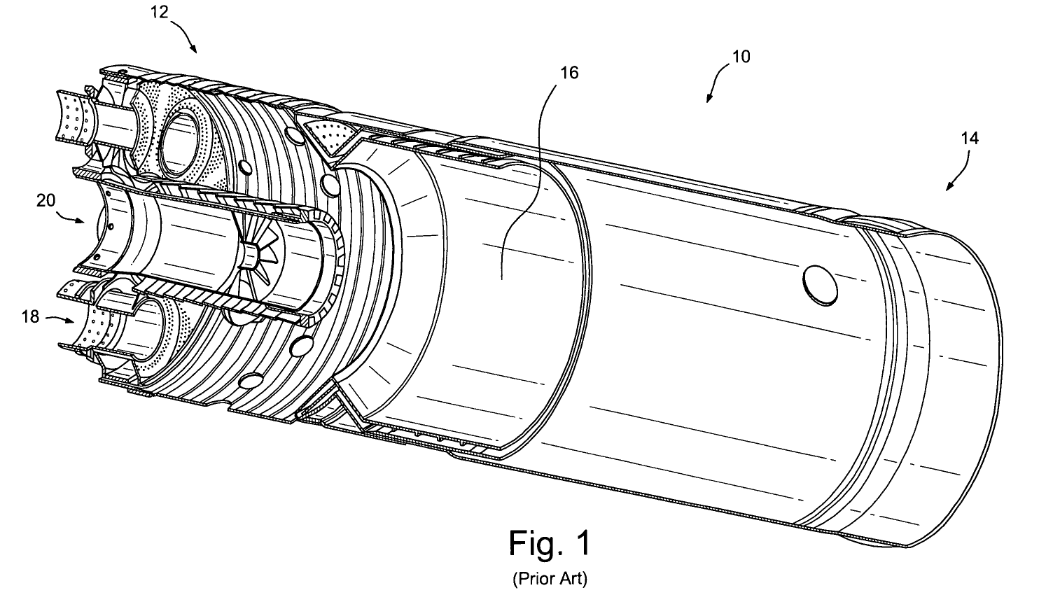

Referring initially to FIG. 1, a known combustor liner 10 includes a forward end 12 and an aft end 14. The combustor liner defines and incorporates a combustion chamber 16 in which fuel and air are mixed and burned. The forward end 12 of the liner 10 is fitted with a nozzle assembly that may include a plurality of radially outer nozzles 18 arranged about a single centered nozzle 20. The nozzle assembly per se, however, forms no part of this invention.

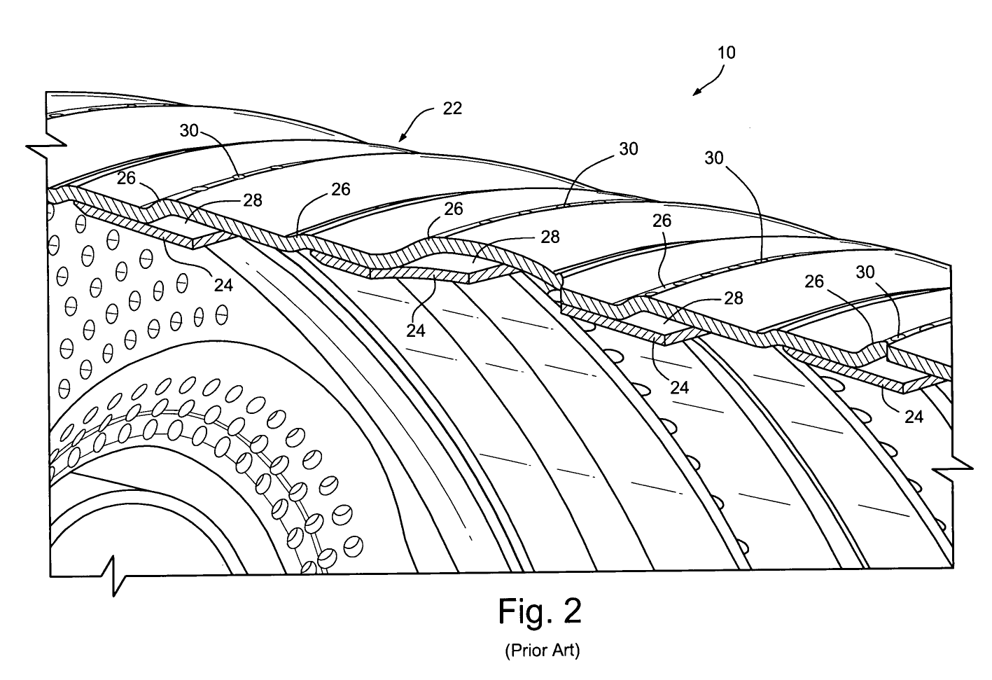

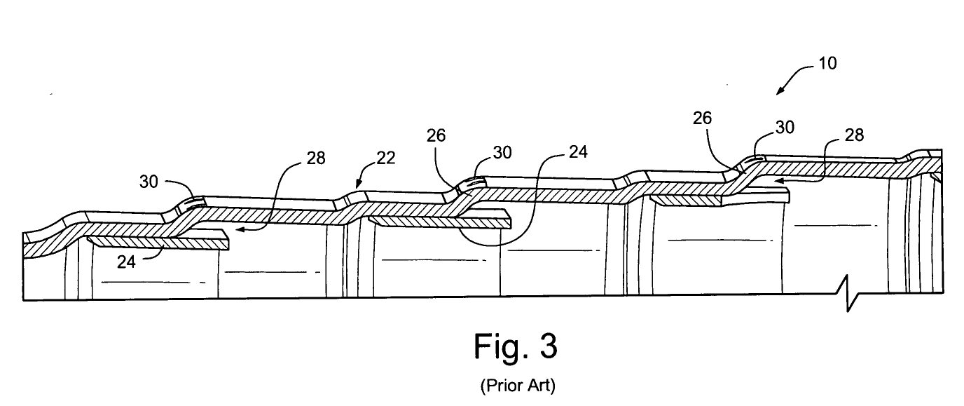

With further reference to FIGS. 2 and 3, the forward end 12 of the liner 10 comprises a hollow cylindrical stepped or shouldered section 22 composed of plural annular panels connected in end-to-end relationship. On the inside of this section of the liner, a series of annular rings 24 are provided which underlie and extend beyond respective shoulders or steps 26 formed in the liner to thereby form a series of aft-facing, annular slots 28.

The shoulders 26 of the liner section 22 are formed with axially-spaced rows of circumferentially spaced cooling holes 30 which are adapted to direct compressor cooling air into contact with the annular rings (or louvers) 24 so that the cooling air will form a film along the inside of the liner.

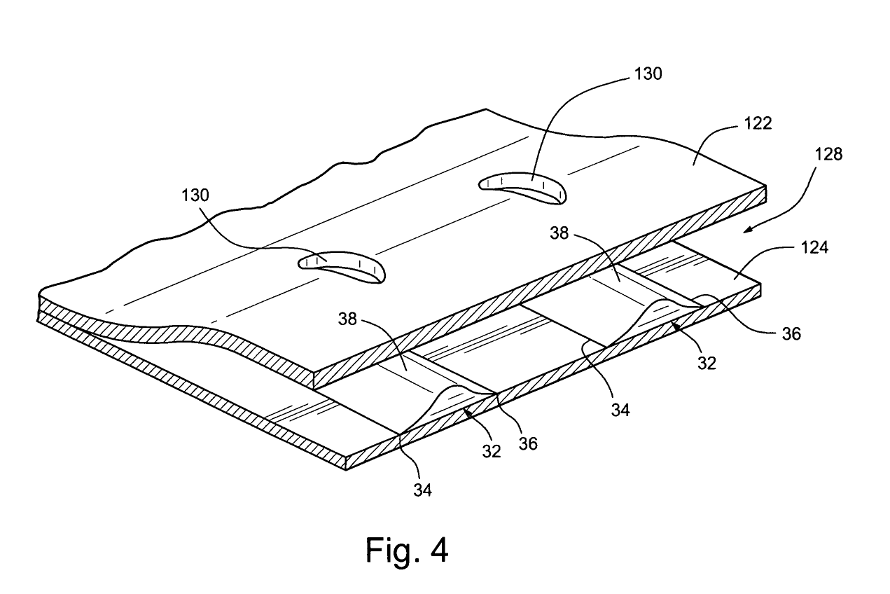

With reference now to FIG. 4, a modified combustor section 122 is illustrated that incorporates an exemplary but nonlimiting embodiment of the invention. Specifically, the upper (or radially outer) surfaces of the annular rings 124 provided on the interior of the combustor section 122, are provided with an annular array of flow disseminators 32. The elongated flow disseminators 32 are located within the slots 128, radially underneath at least some, and preferably all, of the cooling holes 130. In the exemplary but non-limiting embodiment, the flow disseminators 32 extend in an axial direction and are substantially bell-shaped in transverse cross-section, with two axially-oriented edges or ends 34, 36 curving upwardly to a reversely curved (i.e., radially-outwardly convex) apex 38. The flow disseminators 32 may be hollow or solid and may be fixed to the rings 24 by any suitable means, including, for example, welding. Since the disseminators 32 are smoothly-contoured protrusions on the flat surfaces of the cooling rings 124, they could also be made integral with the cooling rings 124, so that the manufacturing cost does not necessarily increase by the addition of the disseminators.

With the flow disseminators 32 facing the cooling holes 130, the cooling jets flowing through those holes are split and smoothly diverted onto either side (i.e., in opposite circumferential directions) of the disseminator apex 38, thereby spreading the otherwise axial cooling flow out of the slots 128, reducing the flow stagnation area. As a result, it can be expected that pressure loss will be reduced and cooling flow made more uniform, which, in turn, will improve the cooling rate and avoid high local thermal gradients. In addition, since the cooling flow is disseminated to either side of the slot cooling holes 130, the distance between the slot cooling holes can be increased. In other words, the number of slot cooling holes 130 in any given annular row can be reduced with no impact on cooling efficiency.

It will be appreciated that other flow disseminator configurations may be suitable, e.g. disseminators having convex semi-circular or triangular cross sections etc. and that the flow disseminator concept is equally applicable to other film cooling applications on other turbine components such as, for example, transition pieces and the like.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A combustor component comprising:
a hollow cylindrical body, at least a section of which is provided with a plurality of annular, axially spaced shoulders;
a plurality of rings on an interior side of said section of said cylindrical body, aligned with said plurality of annular axial-spaced shoulders to thereby create a like plurality of annular slots;
a plurality of cooling holes in said section of said cylindrical body radially overlying said plurality of rings, and adapted to supply cooling air to said plurality of annular slots; and
a plurality of flow disseminators on a radially outer side of said plurality of rings, aligned with said plurality of cooling holes, and configured to spread the cooling air flowing through said plurality of cooling holes.

2. The combustor component of claim 1 wherein each of said plurality of flow disseminators projects radially outwardly and has a radially outwardly convex apex.

3. The combustor component of claim 1 wherein each of said plurality of flow disseminators comprises a convexly-shaped, hollow component fixed to said radially outer surface of said plurality of rings.

4. The combustor component of claim 1 wherein each of said disseminators comprises a convexly-shaped, hollow component integrally formed with said rings.

5. The combustor component of claim 2 wherein each of said plurality of flow disseminators has a bell-shaped transverse cross section.

6. The combustor component of claim 3 wherein each said plurality of flow disseminators has a bell-shaped transverse cross section.

7. The combustor component of claim 1 wherein said section comprises a forward section of a combustor liner.

8. The combustor component of claim 1 wherein said plurality of annular rings are welded to an interior surface of said interior side of said section of said hollow cylindrical body, at a location adjacent and forward of said plurality of annular, axially-spaced shoulders.

9. A combustor liner comprising:
a hollow cylindrical body, at least a forward section of which is provided with a plurality of annular, axially spaced shoulders;
a plurality of rings on an interior side of said forward section of said cylindrical body, aligned with said plurality of annular, axially-spaced shoulders to thereby create a like plurality of axially-facing annular slots;
a plurality of cooling holes in said forward section of said cylindrical body, radially overlying said plurality of rings, and adapted to supply cooling air to said plurality of axially-facing annular slots; and
a plurality of circumferentially-spaced, elongated flow disseminators on a radially outer side of said plurality of rings, said plurality of flow disseminators each having a bell-shaped transverse cross section including a radially outwardly convex apex aligned with a respective one of said plurality of cooling holes, and configured to spread the cooling air flowing through said plurality of cooling holes.

10. The combustor liner of claim 9 wherein each of said plurality of flow disseminators comprises a hollow member welded to said radially outer surfaces of said plurality of rings.

11. A method of cooling a combustor liner comprising:
(a) supplying cooling air though a plurality of cooling holes in the liner to a plurality of axially-spaced annular slots formed in said liner, radially inwardly of said plurality of cooling holes; and
(b) disseminating the cooling air exiting at least some of said plurality of cooling holes by spreading the flow in at least two substantially opposite circumferential directions.

12. The method of claim 11 including, in step (b), disseminating the cooling air exiting all of said plurality of cooling holes.

13. The method of claim 11 wherein step (b) is carried out by adding a flow disseminator in at least some of said plurality of axially-spaced annular slots, underlying said plurality of cooling holes.
